(19) United States
(12) Patent Application Publication
(10) Pub. No.: US 2015/0168336 A1
(43) Pub. Date: Jun. 18, 2015

(54) ELECTRODE AND METHOD FOR MAKING AN ELECTRODE

(71) Applicant: Saint-Gobain Performance Plastics Corporation, Aurora, OH (US)

(72) Inventors: Antoine Diguet, Aubervilliers (FR); Charles Leyder, Paris (FR)

(21) Appl. No.: 14/570,794

(22) Filed: Dec. 15, 2014

Related U.S. Application Data
(60) Provisional application No. 61/916,569, filed on Dec. 16, 2013.

(51) Int. Cl. G01N 27/327; B05D 1/28

(52) U.S. Cl. CPC G01N 27/3271; B05D 1/28; G01N 27/3272

(57) ABSTRACT

An electrode contains a first layer and a second layer. The first layer can be a dielectric layer and the second layer can be a layer containing a metal. A method for forming an electrode includes depositing the first layer and the second layer on a substrate.

### CROSS-REFERENCE TO RELATED APPLICATION(S)

The present application claims priority from U.S. Provisional Patent Application No. 61/916,569, filed Dec. 16, 2013, entitled “ELECTRODE AND METHOD FOR MAKING AN ELECTRODE,” naming inventors Antoine Diguet and Charles Leyder, and said provisional application is incorporated by reference herein in its entirety for all purposes.

### FIELD OF THE DISCLOSURE

The present disclosure relates to an electrode, and more particularly to, a thin film electrode for biosensor applications.

### RELATED ART

WO 2013/052092 describes an electrochemical glucose biosensor comprising two electrodes with at least one of electrodes having both a metallic layer and a non-metallic layer in direct contact with the metallic layer. The reactivity of some noble metal electrodes is generally more pronounced immediately after production and significantly aged products can be eliminated from use. The non-metallic layer is a carbon layer that is used to create an activated electrode that, when new, mimics the characteristics of a non-activated product that has not been aged. In other words, the sensitivity of the electrode is sacrificed for a consistent reading of potential.

However, there is a continuing need for an electrode with improved performance. For example, reducing the amount of metal, particularly expensive metals such as gold, used in the electrode can reduce cost. Further, there remains a need for an electrode with a reduced amount of metal that can maintain performance. Moreover, there remains a need for an electrode with improved sheet resistance.

### BRIEF DESCRIPTION OF THE DRAWINGS

Embodiments are illustrated by way of example and are not limited by the accompanying figure.

FIG. 1 shows an embodiment of an electrode according to this disclosure.

Skilled artisans appreciate that elements in the figures are illustrated for simplicity and clarity and have not necessarily been drawn to scale. For example, the dimensions of some of the elements in the figures can be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but can include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item can be used in place of a single item. Similarly, where more than one item is described herein, a single item can be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and can be found in textbooks and other sources within the electrode and bionsensor arts.

The following disclosure describes an electrode containing a substrate, a first layer (which can be a dielectric layer), and a second layer (which can be a layer containing a metal). In certain embodiments, the electrode can be a thin film electrode, such as a thin film electrode for biosensors that measure the glucose level in a sample, such as a blood sample. The following disclosure also describes biosensor test strips that may include an electrode and methods of forming an electrode. The electrode may include a substrate, a first layer, and a second layer. The introduction of the first layer as described herein can improve the quality of the electrode. For example, it is possible to improve the sheet resistance, or decrease the amount of material used for the second layer, particularly the amount of expensive metals such as gold, and maintain the same sheet resistance, as compared to an electrode without the first layer. The concepts are better understood in view of the embodiments described below that illustrate and do not limit the scope of the present invention.

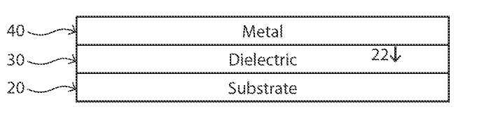

FIG. 1 illustrates an electrode 10 containing a substrate 20, a first layer 30, and a second layer 40 disposed on the substrate 20. As illustrated, the first layer 30 can be disposed directly adjacent the substrate 20 such that the first layer 30 is directly contacting the substrate 20. Additionally, the second layer 40 can be disposed directly adjacent the first layer 30 such that the second layer 40 is directly contacting the first layer 30.

In certain embodiments, the first layer can directly contact the substrate, the second layer, or both. In particular embodiments, the electrode can include additional layers. For example, the electrode can include intermediate layer(s) disposed between one or more of the substrate, the first layer, and the second layer.

An electrode according to this disclosure can be an inert electrode, such as an inert thin film electrode. As described below, the first layer can be a dielectric layer and the second layer can be a layer that may include a metal.

In certain embodiments, the electrode can be a biosensor electrode, such as, for example, a biosensor electrode that can measure the glucose level of a sample, such as a blood sample. In particular embodiments, the electrode can contain a layer comprising a chemical solution, such as a solution containing an enzyme, a mediator, an indicator, or any combination thereof. In particular embodiments, the electrode can be reactive to glucose. For example, glucose can be indirectly degraded by the electrode by first reacting with an enzyme to form a subproduct and the electrode is reactive with the subproduct.

The electrode can be part of a biosensor, such as a biosensor test strip adapted to measure the level of glucose in a sample, such as a blood sample. In certain embodiments, the test strip can include a working electrode and a counter electrode and the electrode described herein can be present as the working electrode, the counter electrode, or both.

In certain embodiments, the first layer and the second layer can be epitaxial layers and, particularly, heteroepitaxial layers. In more particular embodiments, the first layer can be a growth underlayer and the second layer can be an epitaxial overlayer. Epitaxy refers to the deposition of a crystalline overlayer over a crystalline underlayer. Homoepitaxy refers to the overlayer and the underlayer being formed of the same material. Heteroepitaxy refers to the epitaxial overlayer being formed on a growth underlayer of a different material. In epitaxial growth, the underlayer can act as a seed crystal locking the overlayer into one or more ordered crystallographic orientations with respect to the underlayer. Growth can be non-epitaxial if the overlayer does not form an ordered layer with respect to the underlayer.

In certain embodiments, the introduction of a growth underlayer can improve the quality of the electrode, such as to improve its sheet resistance. In other words, as compared to an electrode without the growth underlayer, it has been surprisingly discovered that in certain embodiments, it is possible to decrease the amount of metal in the epitaxial overlayer by about 10% while maintaining the same sheet resistance of the electrode.

Sheet resistance measures the electrical resistance of thin films that are nominally uniform in thickness. Commonly, electrical resistivity is presented in units such as Ω·cm. To obtain a sheet resistance value, electrical resistivity is divided by the sheet thickness, and the unit can be represented as Ω. To avoid being misinterpreted as bulk resistance of 1 ohm, an alternate common unit for sheet resistance is “ohms per square” (denoted “Ω/sq” or “Ω/□”), which is dimensionally equal to an ohm, but is exclusively used for sheet resistance.

While the sheet resistance is a measure of the whole electrode, the contribution of the substrate and the first layer are negligible. For example, in one embodiment, the substrate can provide no contribution to the sheet resistance of the electrode. In further embodiments, the contribution of a 5 nm AZO underlayer to the total measured sheet resistance of the electrode is negligible, such as about 0.0005 Ohm/sq.

In certain embodiments, the electrode can have a sheet resistance of no greater than 2.0 Ohms/sq, such as, no greater than 1.95 Ohms/sq, no greater than 1.9 Ohms/sq, no greater than 1.85 Ohms/sq, no greater than 1.8 Ohms/sq, no greater than 1.75 Ohms/sq, no greater than 1.7 Ohms/sq, no greater than 1.65 Ohms/sq, no greater than 1.6 Ohms/sq, no greater than 1.55 Ohms/sq, or no greater than 1.5 Ohms/sq. In further embodiments, the electrode can have a sheet resistance of no less than 0.7 Ohms/sq, such as, no less than 0.75 Ohms/sq, no less than 0.8 Ohms/sq, or no less than 0.85 Ohms/sq. Moreover, the electrode can have a sheet resistance in a range of any of the maximum and minimum values described above, such as in the range of from 1.0 Ohms/sq to 2.0 Ohms/sq, or from 1.2 Ohms/sq to 1.8 Ohms/sq.

As discussed above, the sheet resistance of the electrode can be related, such as directly proportional, to the thickness of the second layer (or the layer comprising a metal). In other words, in certain embodiments, the sheet resistance of the electrode can tend to decrease as the thickness of the second layer increases. In addition, as discussed above, it has been surprisingly discovered that it is possible to decrease the amount of material used for the second layer while maintaining the same sheet resistance as a conventional electrode, such as without a first layer.

In certain embodiments where the second layer has a thickness of 50 nm, the electrode can have a sheet resistance of no greater than 1.50 Ohm/sq, such as, no greater than 1.40 Ohm/sq, no greater than 1.30 Ohm/sq, no greater than 1.20 Ohm/sq, no greater than 1.10 Ohm/sq, no greater than 1.09 Ohm/sq, no greater than 1.08 Ohm/sq, or even no greater than 1.07 Ohm/sq. In further such embodiments, the electrode can have a sheet resistance of no less than 0.1 Ohm/sq, such as, no less than 0.2 Ohm/sq, no less than 0.3 Ohm/sq, no less than 0.4 Ohm/sq, no less than 0.5 Ohm/sq, no less than 0.6 Ohm/sq, or even no less than 0.7 Ohm/sq. Moreover, certain embodiments of the electrode having a second layer with a thickness of 50 nm can have a sheet resistance in a range of any of the maximum and minimum values described above, such as in the range of from 0.6 Ohm/sq to 1.5 Ohm/sq, from 0.6 Ohm/sq to 1.3 Ohms/sq, or from 0.7 Ohm/sq to 1.1 Ohm/sq.

In certain embodiments where the second layer has a thickness of 45 nm, the electrode can have a sheet resistance of no greater than 1.7 Ohm/sq, such as, no greater than 1.6 Ohm/sq, no greater than 1.5 Ohm/sq, no greater than 1.4 Ohm/sq, or no greater than 1.3 Ohm/sq. In further such embodiments, the electrode can have a sheet resistance of no less than 0.4 Ohm/sq, such as, no less than 0.5 Ohm/sq, no less than 0.6 Ohm/sq, no less than 0.7 Ohm/sq, no less than 0.8 Ohm/sq, no less than 0.9 Ohm/sq, or even no less than 1.0 Ohm/sq. Moreover, certain embodiments of the electrode having a second layer with a thickness of 45 nm can have a sheet resistance in a range of any of the maximum and minimum values described above, such as in the range of from 0.8 Ohm/sq to 1.7 Ohm/sq, from 0.9 Ohm/sq to 1.5 Ohms/sq, or from 1.0 Ohm/sq to 1.3 Ohm/sq.

In certain embodiments where the second layer has a thickness of 40 nm, the electrode can have a sheet resistance of no greater than 1.8 Ohm/sq, such as, no greater than 1.7 Ohm/sq, no greater than 1.6 Ohm/sq, no greater than 1.5 Ohm/sq, or no greater than 1.4 Ohm/sq. In further such embodiments, the electrode can have a sheet resistance of no less than 0.5 Ohm/sq, such as, no less than 0.6 Ohm/sq, no less than 0.7 Ohm/sq, no less than 0.8 Ohm/sq, no less than 0.9 Ohm/sq, no less than 1.0 Ohm/sq, or even no less than 1.1 Ohm/sq. Moreover, certain embodiments of the electrode having a second layer with a thickness of 40 nm can have a sheet resistance in a range of any of the maximum and minimum values described above, such as in the range of from 0.9 Ohm/sq to 1.8 Ohm/sq, from 1.0 Ohm/sq to 1.6 Ohms/sq, or from 1.1 Ohm/sq to 1.4 Ohm/sq.

The substrate, first layer, second layer, and any additional layers are described in more detail below.

The substrate 20 can be constructed out of any material suitable for the substrate of an electrode. In certain embodiments, the material forming the substrate can contain a polymer, a flexible polymer, or a transparent polymer. Suitable polymers can include, for example, polycarbonate, polyacrylate, polyester, polyethylene terephthalate (PET), polyethylene naphthalate (PEN), cellulose triacetated (TCA or TAC), polyurethane, or any combination thereof. In particular embodiments, the substrate can be a glass substrate, such as a transparent glass substrate.

In certain embodiments, the substrate has a thickness suitable for an electrode. In particular embodiments, the substrate can have a thickness of no less than 50 microns, such as, no less than 40 microns, no less than 30 microns, no less than 20 microns, or no less than 10 microns. In particular embodiments, the substrate can have a thickness of no greater than 1,000 microns, such as, no greater than 750 microns, no greater than 500 microns, no greater than 400 microns, or no greater than 300 microns. In further embodiments, the substrate can have a thickness in a range of any of the above minimum and maximum values described above, such as in a range of from 20 microns to 500 microns or from 40 microns to 300 microns. In very particular embodiments, the substrate can have a thickness in a range of from 100 microns to 300 microns.

The surface 22 of the substrate 20 adjacent to first layer 30 can be mechanically treated to improve adhesion between the substrate and first layer 30. For example, mechanically treating the surface 22 of the substrate 20 can include blasting or mechanically etching the surface 22 of the substrate 20. The surface 22 of the substrate 20 can be mechanically treated. In certain embodiments, the surface 22 of the substrate 20 has a surface roughness (Rᵣₘₛ) in a range of from 1 nm to 200 nm. In particular embodiments, the surface 22 of the substrate 20 has a surface roughness (Rᵣₘₛ) in a range of from 100 nm to about 200 nm, from about 120 nm to about 180 nm, or even from about 140 nm to about 160 nm. In further particular embodiments, the surface 22 of the substrate 20 has a surface roughness (Rᵣₘₛ) in a range of from 1 nm to 5 nm, from 1 nm to 4 nm, or even from 1 nm to 3 nm.

Referring again to FIG. 1, first layer 30 can be disposed over substrate 20. For example, first layer 30 can be disposed between substrate 20 and second layer 40. The first layer can contain one or more of the following materials and the one or more materials contained in the first layer can have one or more, or even all, of the following characteristics.

In certain embodiments, the first layer can comprise an inorganic material, an oxide, a metal oxide, or a dielectric compound. In particular embodiments, the dielectric layer can contain a dielectric material. For example, the particular dielectric materials can contain an inorganic compound, such as a metal oxide. Suitable metal oxides include zinc oxide, indium oxide, tin oxide, cadmium oxide, or any combination thereof. For example, suitable metal oxides include aluminum zinc oxide (AZO), indium tin oxide (ITO), antimony tin oxide (ATO), fluorine tin oxide (FTO), or any combination thereof. In very particular embodiments, the first layer can contain AZO.

In certain embodiments, the decrease in sheet resistance can occur when the crystal structure of the first layer matches or closely matches the crystal structure of the second layer. The crystal structure of a material (the arrangement of atoms within a given type of crystal) can be described in terms of its simplest repeating unit, referred to as a unit cell, having unit-cell-edge lengths a, b, and c, referred to as lattice parameters. In this context, the crystal structure of the first layer closely matches the crystal structure of the second layer when the lattice parameters a of the first layer (a₁) and the second layer (a₂) satisfy the following formula:

([sqrt(2)/2]*a₂)/a₁=x,

where x represents a value of no less than 0.65. In particular embodiments, x represents a value of no less than 0.70, no less than 0.75, no less than 0.80, no less than 0.82, no less than 0.84, or no less than 0.86. In further particular embodiments, x represents a value of no greater than 1.5, no greater than 1.4, no greater than 1.3, no greater than 1.2, no greater than 1.1, or no greater than 1.0. Moreover, x can represent a value in a range of any of the above minimum and maximum values described above, such as in a range of from 0.75 to 1.4, from 0.84 to 1.2, or even from 0.86 to 1.0.

For example, the crystal structure of gold is face centered cubic (fcc) and its lattice parameter a is 0.408 nm. Because the crystal structure of gold is cubic, it can have only one lattice parameter. Under ambient conditions, ZnO mainly crystallizes under wurtzite form. Lattice parameters for ZnO in wurtzite form are a=0.325 nm and c=0.520 nm. When this form is oriented in the so-called (002) orientation, the surface can have atom distances similar to that of gold when the gold crystal is oriented in the so called (111) orientation. That is, ([sqrt(2)/2]×a_{An})˜a_{ZnO}, which corresponds to 0.29 nm˜0.33 nm. The effect with AZO (=ZnO:Al) can be similar, even when Al atoms are intercalated in the network. In very particular embodiments, AZO and gold can be used as first and second layers, respectively.

On the other hand, if Au is deposited on another dielectric, such as TiOx, the heteroepitaxy effect is not effective since the mismatch between crystal structures is high. For example, when TiOx is deposited by magnetron sputtering without thermal treatment, the material can be amorphous (in this case there is no specific order) or can have a rutile crystal structure. A rutile crystal structure has a body-centered tetragonal unit cell with a=b=0.458 nm and c=0.295 nm. In certain embodiments, from this structure, TiOx does not appear to have a crystal structure that closely matches the crystal structure of an Au unit cell, regardless of orientation. In particular embodiments, the first layer can be free of tin oxide.

In particular embodiments, the first layer does not contain carbon. In further particular embodiments, the first layer does not contain carbon in the form of graphite.

In certain embodiments, an inorganic material can be present in the first layer in an amount of no less than 50%, such as, no less than 55%, no less than 60%, no less than 65%, no less than 70%, no less than 75%, no less than 80%, no less than 85%, no less than 90%, or no less than 95% by weight of the first layer. In further embodiments, a dielectric material can be present in the dielectric layer in an amount of 100%, no greater than 99%, no greater than 95%, no greater than 90%, no greater than 85%, no greater than 80%, or no greater than 75% by weight of the first layer. In further embodiments, an inorganic material can be present in the first layer in an amount in a range of any of the above minimum and maximum values described above, such as in a range of from 50% to 100%, 60% to 90%, or 70% to 90% by weight of the first layer.

In certain embodiments, the material that forms the first layer can comprise a crystalline material. In particular embodiments, the crystalline material can be composed of crystallites—such as small crystals, or microscopic crystals, or nanocrystallites, or a combination thereof. Crystallite size refers to the diameter of a single crystallite. One or more crystallites form what is often referred to as a grain. In other words, a grain of the crystalline material can contain one or more crystallites. Thus, in certain embodiments, grain size, which refers to the diameter of a single grain, can be the same as, or different than, crystallite size. The grains of a crystalline material interface at boundaries known as grain boundaries. The number of grain boundaries increase as the grain size decreases.

In certain embodiments, the first layer can contain a polycrystalline material. Polycrystalline material refers to a material composed of crystallites that vary in size and/or orientation. In particular embodiments, the variation or variations can be random or directed.

In certain embodiments, the first layer, or the material contained in the first layer, can have an electrical resistivity (ρ) of no greater 1 Ohm·cm, no greater than 1×10⁻² Ohm·cm, no greater than 8×10⁻³ Ohm·cm, or no greater than 5×10⁻³ Ohm·cm. In further embodiments, the first layer, or the material contained in the first layer, can have an electrical resistivity (ρ) of no less than 1×10⁻⁴ Ohm·cm, no less than 5×10⁻⁴ Ohm·cm, or no less than 1×10⁻³ Ohm·cm. In even further embodiments, the first layer, or the material contained in the first layer, can have an electrical resistivity (ρ) in a range of any of the above minimum and maximum values described above, such as in a range of from 1×10⁻⁵ Ohm·cm to 1 Ohm·cm, 1×10⁻⁴ to 1×10⁻² Ohm·cm, or from 1×10⁻³ to 5×10⁻³ Ohm·cm.

In certain embodiments, the first layer can have a thickness of no greater than 20 nm, such as, no greater than 17 nm, no greater than 15 nm, no greater than 13 nm, no greater than 10 nm, no greater than 7 nm, or no greater than 5 nm. In further embodiments, the first layer can have a thickness of no less than 1 nm, such as, no less than 2 nm, no less than 3 nm, no less than 4 nm, or no less than 5 nm. In even further embodiments, the first layer can have a thickness in a range of any of the above minimum and maximum values described above, such as in a range of from 1 nm to 20 nm, from 3 nm to 10 nm, or from 4 nm to 6 nm. In very particular embodiments, the first layer can have a thickness of from 4 to 6 nm.

In certain embodiments, the first layer can consist essentially of a metal oxide. As used herein, the phrase “consisting essentially of a metal oxide” refers to at least 95 atomic % of a metal oxide. Moreover, in particular embodiments, the second layer can contain an essentially pure metal or in other embodiments, a metal alloy. As used herein, “essentially pure metal” refers to a metal oxide having possible impurities in an amount of less than about 5 atomic %.

Referring again to FIG. 1, second layer 40 can be disposed over substrate 20, such as over first layer 30 and substrate 20. For example, second layer 40 can be disposed over first layer 30 and substrate 20 such that first layer 30 is disposed between second layer 40 and substrate 20, such as over and substrate 20. The second layer can contain one or more of the following materials and the one or more materials contained in the second layer can have one or more, or even all, of the following characteristics.

The second layer can be described in terms of its thickness. In certain embodiments, the second layer can have a thickness of from has a thickness of no less than 20 nm, such as, greater than 20 nm, no less than 25 nm, no less than 30 nm, no less than 35 nm, no less than 40 nm, no less than 45 nm, or no less than 50 nm. In further embodiments, the second layer can have a thickness of no greater than 70 nm, such as, less than 70 nm, no greater than 65 nm, no greater than 60 nm, no greater than 55 nm, or no greater than 50 nm. In even further embodiments, the second layer can have a thickness in a range of any of the above minimum and maximum values described above, such as in a range of from 20 nm to 70 nm, from 30 nm to 60 nm, or from 40 nm to 50 nm. In very particular embodiments, the first layer can have a thickness in a range of from 40 nm to 50 nm or from 35 nm to 45 nm.

In certain embodiments, the second layer can comprise a film, such as a thin film. In particular embodiments, the second layer can comprise a thin film having a thickness in the ranges described above for the second layer.

In certain embodiments, the second layer can have a Total Thickness Variation (TTV) of no greater than 15 nm, no greater than 10 nm, no greater than 8 nm, no greater than 6 nm, no greater than 5 nm, or even no greater than 4 nm. As used herein, the TTV is the difference between maximum and minimum thickness values along a square millimeter segment spanning the length and width of the sheet. This difference can also be described as a percentage, such as a percentage of the segment having the highest thickness value. The percentage can be no greater than 20%, no greater than 15%, no greater than 12%, or no greater than 10%.

The second layer can be described in terms of its performance, such as Visible Light Transmittance (VLT). VLT is a measure of the amount the visible spectrum (380 to 780 nanometers) that is transmitted through a composite, typically presented as a percentage. The VLT can be measured according to standard ISO 9050. Although ISO 9050 refers to glazings, the same procedure can be used with a film taped or otherwise adhered to a transparent substrate.

In certain embodiments, the second layer can have a VLT of no greater than 40%, no greater than 35%, no greater than 30%, no greater than 25%, no greater than 20%, no greater than 15%, no greater than 10%, no greater than 5%, no greater than 4%, no greater than 3%, no greater than 2%, or no greater than 1%. In further embodiments, the second layer can have a VLT of no less than 10%, no less than 5%, no less than 4%, no less than 3%, no less than 2%, or no less than 1%. In even further embodiments, the second layer can have a VLT of 0%. Moreover, the second layer can have a VLT in a range of any of the maximum and minimum values described above, such as in the range of from 0% to 40%, from 5% to 20%, or from 7.5% to 12%.

In certain embodiments, the second layer can be substantially non-transparent, such as non-transparent. Substantially non-transparent refers to having a VLT of no greater than about 10% and non-transparent refers to having a VLT of no greater than 1%.

The VLT of the second layer can be related, such as inversely proportional, to the thickness of the second layer. In other words, in certain embodiments, the VLT of the second layer can tend to decrease as the thickness of the second layer increases. In particular embodiments, when the second layer has a thickness of 50 nm, the second layer can have a VLT of no greater than 20%, no greater than 15%, or no greater than 10%. In further particular embodiments, when the second layer has a thickness of 45 nm, the second layer can have a VLT of no greater than 25%, no greater than 20%, or no greater than 15%. In even further particular embodiments, when the second layer has a thickness of 40 nm, the second layer can have a VLT of no greater than 30%, no greater than 25%, or no greater than 20%.

In certain embodiments, the second layer can contain a metal. Suitable metals can include noble metals. In certain embodiments, the second layer can contain ruthenium, rhodium, palladium, silver, osmium, iridium, platinum, gold, or any combination thereof. In particular embodiments, the second layer can contain silver or gold. In very particular embodiments, the second layer can contain gold.

In certain embodiments, the second layer can contain a metal in an amount of no less than 50%, no less than 60%, no less than 70%, no less than 80%, no less than 90%, or no less than 99% by weight of the second layer. In further embodiments, the second layer can contain a metal in an amount of from no greater than 70%, no greater than 80%, no greater than 90%, no greater than 99% by weight of the second layer. Moreover, the second layer can contain a metal in an amount in a range of any of the maximum and minimum values described above, such as in the range of from 60% to 70%, or from 70% to 80%, or from 80% to 90%, or from 90% to 95%, or from 95% to 100%.

In certain embodiments, the second layer can contain a material, such as a metal, having a conductivity of no greater than 1×10⁻⁵ Ohm·cm, no greater than 9×10⁻⁶ Ohm·cm, no greater than 8×10⁻⁶ Ohm·cm, no greater than 7×10⁻⁶ Ohm·cm, or no greater than 6×10⁻⁶ Ohm·cm. In certain embodiments, the second layer can contain a material, such as a metal, having a conductivity of no less than 1×10⁻⁶ Ohm·cm, no less than 2×10⁻⁶ Ohm·cm, no less than 3×10⁻⁶ Ohm·cm, or no less than 4×10⁻⁶ Ohm·cm. Moreover, the second layer can contain a material, such as a metal, having a conductivity in a range of any of the maximum and minimum values described above, such as in the range of from 1×10⁻⁶ to 1×10⁻⁵ Ohm·cm or from 3×10⁻⁶ to 8×10⁻⁶ Ohm·cm. In very particular embodiments, the second layer can contain a metal having a conductivity of from 4×10⁻⁶ to 6×10⁻⁶ Ohm·cm.

In certain embodiments, the second layer can contain a polycrystalline material. In particular embodiments, the polycrystalline material can have random or directed variations. In further embodiments, the crystals or crystallites in the polycrystalline material can have a certain structure or system, such as a face-centered crystal cubic system.

In certain embodiments, the second layer can consist essentially of a metal. As used herein, the phrase “consisting essentially of a metal” refers to at least 95 atomic % of a metal. Moreover, in particular embodiments, the second layer can contain an essentially pure metal or in other embodiments, a metal alloy. As used herein, “essentially pure metal” refers to a metal having possible impurities in an amount of less than about 5 atomic %.

In other embodiments, the second layer any of the one or more metal based layers can contain a metal alloy, such as for example containing a predominant metal in a concentration of at least about 70 atomic %, and a minor metal in a concentration of less than about 30 atomic % based on the total weight of the metal based layer. In particular embodiments, the second layer can contain an alloy of noble metals. In particular embodiments, the second layer can contain a metal alloy that includes two or more of the noble metals listed above. In very particular embodiments, the second layer can contain an alloy of silver and gold, such as a 50/50 alloy of silver and gold.

As discussed above, Applicants discovered that it is possible to decrease the amount of metal in the second layer and achieve a sheet resistance similar to that of an electrode without a first layer, particularly a dielectric layer. For example, the second layer having a thickness of 50 nm can comprise metal in an amount in a range of from 0.8 to 1.0 g/m². As shown in the Examples, that amount can be reduced by about 10%, such as by reducing the thickness of the second layer to a 45 nm, and achieve a sheet resistance similar to that of a 50 nm metal layer in an electrode without a first layer, particularly a dielectric layer. In certain embodiments, the second layer can contain metal in an amount of from 0.65 g/m² to 0.95 g/m², from 0.67 g/m² to 0.93 g/m², or even from 0.70 g/m² to 0.91 g/m².

Also described herein are electrochemical sensors. In certain embodiments, the electrochemical sensors can be adapted to detect the presence of, and/or measure the concentration of, an analyte by way of electrochemical oxidation and reduction reactions within the sensor. These reactions can be transduced to an electrical signal that can be correlated to an amount or concentration of the analyte. In certain embodiments, the electrochemical sensor can be a biosensor test strip.

In particular embodiments, the test strip can include a base substrate, a spacing layer, a covering layer, or any combination thereof. The base substrate can include an electrode system and the electrode system can include a set of measuring electrodes, e.g., at least a working electrode and a counter electrode, within a sample-receiving chamber. One or more of the electrodes in the electrode system can include an electrode as described herein.

Further, in particular embodiments, the spacing layer of the test strip can define a sample-receiving chamber extending between the base substrate and the covering layer. The sample-receiving chamber can be adapted such that a sample fluid can enter a chamber and be placed in electrolytic contact with both the working electrode and the counter electrode. Such contact can allow electrical current to flow between the measuring electrodes to effect the electrooxidation or electroreduction of the analyte. In very particular embodiments, the sample fluid can be a blood sample, such as a human blood sample, and the sensor can be adapted to measure the glucose level in such a sample.

Moreover, a suitable reagent system can overlie at least a portion of the electrodes or electrode pairs within the sample-receiving chamber. The reagent system can include additives to enhance the reagent properties or characteristics. For example, additives can include materials to facilitate the placement of the reagent composition onto the test strip and to improve its adherence to the strip, or for increasing the rate of hydration of the reagent composition by the sample fluid. Additionally, the additives can include components selected to enhance the physical properties of the resulting dried reagent layer, and the uptake of a liquid test sample for analysis. In certain embodiments, the additives can include thickeners, viscosity modulators, film formers, stabilizers, buffers, detergents, gelling agents, fillers, film openers, coloring agents, agents endowing thixotropy, or any combination thereof.

In further embodiments, the covering layer can be adapted to form a top surface of the sample-receiving chamber. Moreover, the covering layer can be adapted to provide a hydrophilic surface to aid in acquisition of the test sample. In particular embodiments, the covering layer can define a vent opening that allows air to escape from the interior of the chamber as the sample fluid enters and moves into the sample-receiving chamber.

The electrode can be formed according to any appropriate method. In general, forming the electrode includes providing a substrate, depositing the first layer, and depositing the second layer. For example, the first layer can be deposited over the substrate and the second layer can be deposited over the first layer. In certain embodiments, the first layer can be deposited directly onto the substrate. In certain embodiments, the second layer can be deposited directly onto the first layer.

The method can include depositing one or more of the layers by physical vapor deposition, such as sputtering, such as magnetron sputtering. The first layer can be deposited with or without annealing. In certain embodiments, the first layer can be deposited without annealing. The materials used for forming the first layer can have a standard deposition rate.

The first layer and the second layer can be deposited by roll-to-roll processing. Roll-to-roll processing refers to a process of applying coatings starting with a roll of a flexible material and re-reeling after the process to create an output roll. In certain embodiments, the roll-to-roll process can include depositing the first and second layers using two cathodes, such as simultaneously using two cathodes.

Embodiments of the method described herein can increase the production time and the TTV of the coating. The TTV of the coating is described above. In certain embodiment, the method can increase production time by 10% as compared to conventional methods of forming a similar electrode without a first layer, particularly a dielectric layer.

The present disclosure represents a departure from the state of the art. In particular, it has heretofore been unknown how to form an electrode which can provide the performance characteristics, and particularly the combination of performance characteristics described herein. For example, the present disclosure illustrates various electrodes having a dielectric layer and a layer comprising a metal. Such constructions as described in detail herein have unexpectedly been found to exhibit significantly superior sheet resistance that were heretofore impossible to achieve relative to its thickness.

Many different aspects and embodiments are possible. Some of those aspects and embodiments are described below. After reading this specification, skilled artisans will appreciate that those aspects and embodiments are only illustrative and do not limit the scope of the present invention. Embodiments can be in accordance with any one or more of the items as listed below.

Item 1. An electrode comprising:
a substrate;
a first layer comprising an inorganic material; and
a second layer comprising a metal and having a visible light transmittance of 40% or less,
wherein the first layer is disposed between the substrate and the second layer.

Item 2. An electrode comprising:
a substrate;
a first layer comprising an inorganic material; and
a second layer comprising a metal and having a thickness greater than 20 nm,
wherein the first layer is disposed between the substrate and the second layer.

Item 3. An electrode comprising:
a substrate; and
a layer comprising a metal, the layer being disposed over the substrate and having a sheet resistance of 2.0 Ohm/sq or less.

Item 4. An electrode comprising:
a substrate; and
a first layer comprising an inorganic material having a lattice parameter a₁; and
a second layer comprising a metal having a lattice parameter a₂,
wherein a₁ and a₂ satisfy the following formula:

([sqrt(2)/2]*a₂)/a₁=x,
where x represents a value of no less than 0.65.

Item 5. A biosensor test strip comprising:
an electrode system that includes an electrode, the electrode comprising:
   a substrate;
      a first layer comprising an inorganic material; and
   a second layer comprising a metal,
   wherein the first layer is disposed between the substrate and the second layer.

Item 6. A composite comprising:
a substrate;
a first layer comprising an inorganic material; and
a second layer comprising a metal,
wherein the first layer is disposed between the substrate and the second layer, and the second layer
(a) has a visible light transmittance of 40% or less,
(b) has a thickness of greater than 20 nm, or
(c) has a sheet resistance of 2.0 Ohm/sq or less

Item 7. A method of forming an electrode, comprising:
providing a substrate;
depositing on the substrate a first layer comprising an inorganic material; and
depositing heteroepitaxially on the first layer a second layer comprising a metal, the second layer having a thickness of greater than 20 nm.

Item 8. The electrode, biosensor test strip, composite, or method of any of the preceding items, wherein the inorganic material comprises a crystalline material or a polycrystalline material.

Item 9. The electrode, biosensor test strip, composite, or method of any of the preceding items, wherein the inorganic material comprises an oxide, a metal oxide, a transparent oxide, a transparent metal oxide, a dielectric compound, or any combination thereof.

Item 10. The electrode, biosensor test strip, composite, or method of any of the preceding items, wherein the inorganic material comprises zinc oxide, indium oxide, tin oxide, cadmium oxide, or any combination thereof.

Item 11. The electrode, biosensor test strip, composite, or method of any of the preceding items, wherein the inorganic material comprises aluminum zinc oxide (AZO), indium tin oxide (ITO), antimony tin oxide (ATO), fluorine tin oxide (FTO), or any combination thereof.

Item 12. The electrode, biosensor test strip, composite, or method of any of the preceding items, wherein the inorganic material comprises aluminum zinc oxide (AZO).

Item 13. The electrode, biosensor test strip, composite, or method of any of the preceding items, wherein the inorganic material of the first layer has a lattice parameter a₁ and the metal of the second layer has a lattice parameter a₂, where a₁ and a₂ satisfy the following formula:

([sqrt(2)/2]*a₂)/a₁=x,
where x represents a value of no less than 0.70, no less than 0.75, no less than 0.80, no less than 0.82, no less than 0.84, or no less than 0.86.

Item 14. The electrode, biosensor test strip, composite, or method of any of the preceding items, wherein the inorganic material of the first layer has a lattice parameter a₁ and the metal of the second layer has a lattice parameter a₂, where a₁ and a₂ satisfy the following formula:

([sqrt(2)/2]*a₂)/a₁=x,
where x represents a value of no greater than 1.5, no greater than 1.4, no greater than 1.3, no greater than 1.2, no greater than 1.1, or no greater than 1.0.

Item 15. The electrode, biosensor test strip, composite, or method of any of the preceding items, wherein the inorganic material of the first layer has a lattice parameter a₁ and the metal of the second layer has a lattice parameter a₂, where a₁ and a₂ satisfy the following formula:

[(sqrt(2)/2]*a₂)/a₁=x,
where x represents a value in a range of from 0.75 to 1.4, from 0.84 to 1.2, or from 0.86 to 1.0

Item 16. The electrode, biosensor test strip, composite, or method of any of the preceding items, wherein the first layer does not contain tin oxide.

Item 17. The electrode, biosensor test strip, composite, or method of any of the preceding items, wherein the first layer does not contain carbon.

Item 18. The electrode, biosensor test strip, composite, or method of any of the preceding items, wherein the first layer has an electrical resistivity (ρ) in a range of from 1×10⁻⁵ Ohm·cm to 1 Ohm·cm, from 1×10⁻² to 1×10⁻⁴ Ohm·cm, from 8×10⁻³ to 5×10⁻⁴ Ohm·cm, or from 5·10⁻³ to 10⁻³ Ohm·cm.

Item 19. The electrode, biosensor test strip, composite, or method of any of the preceding items, wherein the first layer comprises the inorganic material in an amount of 100% by weight of the first layer, no greater than 99%, no greater than 95%, no greater than 90%, no greater than 85%, no greater than 80%, or no greater than 75%.

Item 20. The electrode, biosensor test strip, composite, or method of any of the preceding items, wherein the first layer comprises the inorganic material in an amount of no less than 50% by weight of the first layer, no less than 55%, no less than 60%, no less than 65%, no less than 70%, no less than 75%, no less than 80%, no less than 85%, no less than 90%, or no less than 95%.

Item 21. The electrode, biosensor test strip, composite, or method of any of the preceding items, wherein the first layer comprises the inorganic material in an amount of from 50% to 100% by weight of the first layer, 60% to 90%, or 70% to 90%.

Item 22. The electrode, biosensor test strip, composite, or method of any of the preceding items, wherein the first layer has a thickness of no greater than 20 nm, no greater than 17 nm, no greater than 15 nm, no greater than 13 nm, no greater than 10 nm, no greater than 7 nm, or no greater than 5 nm.

Item 23. The electrode, biosensor test strip, composite, or method of any of the preceding items, wherein the first layer has a thickness of no less than 1 nm, no less than 2 nm, no less than 3 nm, no less than 4 nm, or no less than 5 nm.

Item 24. The electrode, biosensor test strip, composite, or method of any of the preceding items, wherein the first layer has a thickness of from 1 nm to 20 nm, from 3 nm to 10 nm, or from 4 nm to 6 nm.

Item 25. The electrode, biosensor test strip, composite, or method of any of the preceding items, wherein the metal of the second layer (or the layer comprising a metal) comprises a crystalline material, or a polycrystalline material.

Item 26. The electrode, biosensor test strip, composite, or method of any of the preceding items, wherein the metal of the second layer (or the layer comprising a metal) has a face-centered crystal cubic system.

Item 27. The electrode, biosensor test strip, composite, or method of any of the preceding items, wherein the second layer (or the layer comprising a metal) has a visible light transmittance of no greater than 40%, no greater than 30%, no greater than 25%, no greater than 20%, no greater than 15%, no greater than 10%, no greater than 5%, no greater than 4%, no greater than 3%, no greater than 2%, or no greater than 1%.

Item 28. The electrode, biosensor test strip, composite, or method of any of the preceding items, wherein the second layer (or the layer comprising a metal) has a visible light transmittance of no less than 10%, no less than 5%, no less than 4%, no less than 3%, no less than 2%, or no less than 1%.

Item 29. The electrode, biosensor test strip, composite, or method of any of the preceding items, wherein the second layer (or the layer comprising a metal) has a visible light transmittance of from 0% to 25%, from 5% to 20%, or from 7.5% to 12%.

Item 30. The electrode, biosensor test strip, composite, or method of any of the preceding items, wherein the second layer (or the layer comprising a metal) is a film or a thin film.

Item 31. The electrode, biosensor test strip, composite, or method of any of the preceding items, wherein the metal of the second layer (or the layer comprising a metal) comprises a noble metal.

Item 32. The electrode, biosensor test strip, composite, or method of any of the preceding items, wherein the metal of the second layer (or the layer comprising a metal) comprises ruthenium, rhodium, palladium, silver, osmium, iridium, platinum, gold, or any combination thereof.

Item 33. The electrode, biosensor test strip, composite, or method of any of the preceding items, wherein the metal of the second layer (or the layer comprising a metal) comprises gold.

Item 34. The electrode, biosensor test strip, composite, or method of any of the preceding items, wherein the metal of the second layer (or the layer comprising a metal) has a purity of from 60% to 100%, from 65% to 95%, from 70% to 90%, or from 75% to 85%.

Item 35. The electrode, biosensor test strip, composite, or method of any of the preceding items, wherein the metal of the second layer (or the layer comprising a metal) is an alloy, a noble metal alloy, an alloy of two or more noble metals, an alloy of silver and gold, or a 50/50 alloy of silver and gold.

Item 36. The electrode, biosensor test strip, composite, or method of any of the preceding items, wherein the electrode has a sheet resistance of no greater than 2.0 Ohm/sq, no greater than 1.95 Ohm/sq, no greater than 1.9 Ohm/sq, no greater than 1.85 Ohm/sq, or no greater than 1.8 Ohm/sq.

Item 37. The electrode, biosensor test strip, composite, or method of any of the preceding items, wherein the electrode has a sheet resistance of from 0.70 Ohm/sq to 2.0 Ohm/sq, from 0.75 Ohm/sq to 1.9 Ohm/sq, from 0.8 Ohm/sq to 1.8 Ohm/sq, from 0.85 Ohm/sq to 1.7 Ohm/sq, or from 0.9 Ohm/sq to 1.6 Ohm/sq.

Item 38. The electrode, biosensor test strip, composite, or method of any of the preceding items, wherein the second layer (or the layer comprising a metal) has a thickness of 50 nm and the electrode has a sheet resistance of no greater than 1.50 Ohm/sq, no greater than 1.40 Ohm/sq, no greater than 1.30 Ohm/sq, no greater than 1.20 Ohm/sq, no greater than 1.10 Ohm/sq, no greater than 1.09 Ohm/sq, no greater than 1.08 Ohm/sq, or no greater than 1.07 Ohm/sq.

Item 39. The electrode, biosensor test strip, composite, or method of any of the preceding items, wherein the second layer (or the layer comprising a metal) has a thickness of 50 nm and the electrode has a sheet resistance of no less than 0.1 Ohm/sq, no less than 0.2 Ohm/sq, no less than 0.3 Ohm/sq, no less than 0.4 Ohm/sq, no less than 0.5 Ohm/sq, no less than 0.6 Ohm/sq, or even no less than 0.7 Ohm/sq.

Item 40. The electrode, biosensor test strip, composite, or method of any of the preceding items, wherein the second layer (or the layer comprising a metal) has a thickness of 50 nm and the electrode has a sheet resistance in a range of from 0.6 Ohm/sq to 1.5 Ohm/sq, from 0.6 Ohm/sq to 1.3 Ohms/sq, or from 0.7 Ohm/sq to 1.1 Ohm/sq.

Item 41. The electrode, biosensor test strip, composite, or method of any of the preceding items, wherein the second layer (or the layer comprising a metal) has a thickness of 45 nm and the electrode has a sheet resistance of no greater than 1.7 Ohm/sq, no greater than 1.6 Ohm/sq, no greater than 1.5 Ohm/sq, no greater than 1.4 Ohm/sq, or no greater than 1.3 Ohm/sq.

Item 42. The electrode, biosensor test strip, composite, or method of any of the preceding items, wherein the second layer (or the layer comprising a metal) has a thickness of 45 nm and the electrode has a sheet resistance of no less than 0.4 Ohm/sq, no less than 0.5 Ohm/sq, no less than 0.6 Ohm/sq, no less than 0.7 Ohm/sq, no less than 0.8 Ohm/sq, no less than 0.9 Ohm/sq, or even no less than 1.0 Ohm/sq.

Item 43. The electrode, biosensor test strip, composite, or method of any of the preceding items, wherein the second layer (or the layer comprising a metal) has a thickness of 45 nm and the electrode has a sheet resistance in the range of from 0.8 Ohm/sq to 1.7 Ohm/sq, from 0.9 Ohm/sq to 1.5 Ohms/sq, or from 1.0 Ohm/sq to 1.3 Ohm/sq.

Item 44. The electrode, biosensor test strip, composite, or method of any of the preceding items, wherein the second layer (or the layer comprising a metal) has a thickness of 40 nm and the electrode has a sheet resistance of no greater than 1.8 Ohm/sq, no greater than 1.7 Ohm/sq, no greater than 1.6 Ohm/sq, no greater than 1.5 Ohm/sq, or no greater than 1.4 Ohm/sq.

Item 45. The electrode, biosensor test strip, composite, or method of any of the preceding items, wherein the second layer (or the layer comprising a metal) has a thickness of 40 nm and the electrode has a sheet resistance of no less than 0.5 Ohm/sq, no less than 0.6 Ohm/sq, no less than 0.7 Ohm/sq, no less than 0.8 Ohm/sq, no less than 0.9 Ohm/sq, no less than 1.0 Ohm/sq, or even no less than 1.1 Ohm/sq.

Item 46. The electrode, biosensor test strip, composite, or method of any of the preceding items, wherein the second layer (or the layer comprising a metal) has a thickness of 40 nm and the electrode has a sheet resistance in a range of from 0.9 Ohm/sq to 1.8 Ohm/sq, from 1.0 Ohm/sq to 1.6 Ohms/sq, or from 1.1 Ohm/sq to 1.4 Ohm/sq

Item 47. The electrode, biosensor test strip, composite, or method of any of the preceding items, wherein the second layer (or the layer comprising a metal) has a thickness of no less than 20 nm, greater than 20 nm, no less than 25 nm, no less than 30 nm, no less than 35 nm, no less than 40 nm, no less than 45 nm, or no less than 50 nm.

Item 48. The electrode, biosensor test strip, composite, or method of any of the preceding items, wherein the second layer (or the layer comprising a metal) has a thickness of no greater than 70 nm, less than 70 nm, no greater than 65 nm, no greater than 60 nm, no greater than 55 nm, or no greater than 50 nm.

Item 49. The electrode, biosensor test strip, composite, or method of any of the preceding items, wherein the second layer (or the layer comprising a metal) has a thickness of from 20 nm to 70 nm, from 30 nm to 60 nm, from 40 nm to 50 nm, or from 35 nm to 45 nm.

Item 50. The electrode, biosensor test strip, composite, or method of any of the preceding items, wherein the metal of the second layer (or the layer comprising a metal) has a conductivity of no greater than 1×10⁻⁵ Ohm·cm, no greater than 9×10⁻⁶ Ohm·cm, no greater than 8×10⁻⁶ Ohm·cm, or no greater than 7×10⁻⁶ Ohm·cm, or no greater than 6×10⁻⁶ Ohm·cm.

Item 51. The electrode, biosensor test strip, composite, or method of any of the preceding items, wherein the metal of the second layer (or the layer comprising a metal) has a conductivity of no less than 1×10⁻⁶ Ohm·cm, no less than 2×10⁻⁶ Ohm·cm, no less than 3×10⁻⁶ Ohm·cm, or no less than 4×10⁻⁶ Ohm·cm.

Item 52. The electrode, biosensor test strip, composite, or method of any of the preceding items, wherein the metal of the second layer (or the layer comprising a metal) has a conductivity of from 1×10⁻⁶ to 1×10⁻⁵ Ohm·cm or from 3×10⁻⁶ to 8×10⁻⁶ Ohm·cm.

Item 53. The electrode, biosensor test strip, composite, or method of any of the preceding items, wherein the metal of the second layer (or the layer comprising a metal) has a conductivity of from 4×10⁻⁶ to 6×10⁻⁶ Ohm·cm, or a conductivity of about 5×10⁻⁶ Ohm·cm.

Item 54. The electrode, biosensor test strip, composite, or method of any of the preceding items, wherein the metal of the second layer (or the layer comprising a metal) has a conductivity of from 1×10⁻⁶ Ohm·cm to 1×10⁻⁵ Ohm·cm, from 2×10⁻⁶ to 9×10⁻⁶ Ohm·cm, or from 3×10⁻⁶ to 8×10⁻⁶ Ohm·cm, or from 4×10⁻⁶ Ohm·cm to 6×10⁻⁶ Ohm·cm.

Item 55. The electrode, biosensor test strip, composite, or method of any of the preceding items, wherein the substrate comprises a polymer, a flexible polymer, or a transparent polymer.

Item 56. The electrode, biosensor test strip, composite, or method of any of the preceding items, wherein the substrate comprises polycarbonate, polyacrylate, polyester, polyethylene terephthalate (PET), polyethylene naphthalate (PEN), cellulose triacetated (TCA or TAC), polyurethane, or any combination thereof.

Item 57. The electrode, biosensor test strip, composite, or method of any of the preceding items, wherein the substrate comprises polyethylene terephthalate (PET).

Item 58. The electrode, biosensor test strip, composite, or method of any one of the preceding items, wherein the substrate has a thickness of no less than 50 microns, no less than 45 microns, no less than 40 microns, no less than 35 microns, no less than 30 microns, no less than 25 microns, no less than 20 microns, no less than 15 microns, no less than 10 microns, no less than 5 microns, or no less than 1 micron.

Item 59. The electrode, biosensor test strip, composite, or method of any one of the preceding items, wherein the substrate has a thickness of no greater than 500 microns, no greater than 200 microns, no greater than 100 microns, no greater than 90 microns, no greater than 80 microns, no greater than 75 microns, no greater than 70 microns, no greater than 65 microns, no greater than 60 microns, no greater than 55 microns, or no greater than 50 microns.

Item 60. The electrode, biosensor test strip, composite, or method of any one of the preceding items, wherein the substrate has a thickness in a range of from 25 microns to 75 microns or 40 microns to 60 microns.

Item 61. The electrode, biosensor test strip, composite, or method of any one of the preceding items, wherein the first layer directly contacts the substrate, the first layer directly contacts the second layer, or the first layer directly contacts the substrate and the second layer.

Item 62. The electrode, biosensor test strip, composite, or method of any one of the preceding items, wherein the first and second layers comprise epitaxial layers, wherein the first layer comprises a growth underlayer and the second layer comprises a metallic overlayer.

Item 63. The electrode, biosensor test strip, composite, or method of any one of the preceding items, wherein the electrode further comprises a layer comprising a chemical solution.

Item 64. The electrode, biosensor test strip, composite, or method of any one of the preceding items, wherein the electrode further comprises an enzyme, a mediator, an indicator, or any combination thereof.

Item 65. The electrode, biosensor test strip, composite, or method of any one of the preceding items, wherein the (first) electrode is reactive to glucose.

Item 66. The biosensor test strip of any of the preceding items, wherein the electrode is a working electrode.

Item 67. The biosensor test strip of item 61, wherein the electrode system further comprises a counter electrode.

Item 68. The method of any of the preceding items, wherein the first layer is deposited directly onto the substrate, the layer comprising the metal is deposited directly onto the dielectric layer, or both.

Item 69. The method of any of the preceding items, wherein the first layer is deposited by sputtering, the second layer is deposited by sputtering, or both.

Item 70. The method of any of the preceding items, wherein the first layer and the second layer are deposited simultaneously using a roll-to-roll coater.

Item 71. The method of any of the preceding items, wherein the inorganic material of the first layer has a standard deposition rate.

Item 72. The method of any of the preceding items, wherein the first layer is deposited without annealing.

These and other unexpected and superior characteristics are illustrated in the Example below, which are exemplary and not limiting, in any way, to the embodiments described herein.

### Examples

The electrode of Examples 1-17 were formed by depositing a layer of aluminum-doped zinc oxide (AZO) from a ceramic target and a layer of gold (Au) on a substrate having a thickness of between 50 and 250 microns (Melinex 329 and Melinex ST505 from Dupont Teijin, and SH41 from SKC). The AZO and Au layers were formed on the substrate with a batch magnetron sputtering deposition machine, with a low power density applied on the target. The type of substrate and the thicknesses of the AZO and Au layers for the respective examples are listed in Table 1.

Each example was measured to determine the sheet resistance of the electrode. The measurement was taken according to an electromagnetic non-contact method using a Nagy apparatus. The results are reported in Table 1 below. The VLT of the metal layer in each example was no greater than 40%.

TABLE 1

| | | | | | Sheet |
|---|---|---|---|---|---|
| | | | | R/sq | Resistance |
| | Substrate | AZO | Au | (Ohm/sq) | Improvement |
| Ex. 1 | Melinex 329 | 5 nm | 50 nm | 1.068 | 11.7% |
| Ex. 2 | Melinex 329 | — | 50 nm | 1.209 | |
| Ex. 3 | Melinex 329 | 5 nm | 45 nm | 1.216 | 5.0% |
| Ex. 4 | Melinex 329 | — | 45 nm | 1.280 | |
| Ex. 5 | Melinex 329 | 5 nm | 40 nm | 1.376 | — |
| Ex. 6 | SH41 | 5 nm | 50 nm | 1.007 | 15.5% |
| Ex. 7 | SH41 | — | 50 nm | 1.192 | |
| Ex. 8 | SH41 | 5 nm | 45 nm | 1.110 | 8.3% |
| Ex. 9 | SH41 | — | 45 nm | 1.210 | |
| Ex. 10 | SH41 | 5 nm | 40 nm | 1.304 | 3.9% |
| Ex. 11 | SH41 | — | 40 nm | 1.357 | |
| Ex. 12 | ST505 | 5 nm | 50 nm | 1.000 | 19.5% |
| Ex. 13 | ST505 | — | 50 nm | 1.243 | |
| Ex. 14 | ST505 | 5 nm | 45 nm | 1.121 | 11.9% |
| Ex. 15 | ST505 | — | 45 nm | 1.272 | |
| Ex. 16 | ST505 | 5 nm | 40 nm | 1.241 | 12.7% |
| Ex. 17 | ST505 | — | 40 nm | 1.421 | |

The results in Table 1 confirm an improvement in resistivity on average of more than 10% due to the introduction of the AZO layer. In addition, the results in Table 1 show that 5 nm AZO with 45 nm Au gives a similar or better R/sq to that of 50 nm Au without AZO.

Note that not all of the activities described above in the general description or the examples are required, that a portion of a specific activity can not be required, and that one or more further activities can be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments can also be provided in combination in a single embodiment, and conversely, various features that are, for brevity, described in the context of a single embodiment, can also be provided separately or in any subcombination. Further, reference to values stated in ranges includes each and every value within that range. Many other embodiments can be apparent to skilled artisans only after reading this specification. Other embodiments can be used and derived from the disclosure, such that a structural substitution, logical substitution, or another change can be made without departing from the scope of the disclosure. Accordingly, the disclosure is to be regarded as illustrative rather than restrictive.

What is claimed is:

1. An electrode comprising:
a substrate;
a first layer comprising an inorganic material; and
a second layer comprising a metal and having a visible light transmittance of 40% or less,
wherein the first layer is disposed between the substrate and the second layer.

2. The electrode of claim 1, wherein the inorganic material comprises aluminum zinc oxide (AZO), indium tin oxide (ITO), antimony tin oxide (ATO), fluorine tin oxide (FTO), or any combination thereof.

3. The electrode of claim 1, wherein the inorganic material of the first layer has a lattice parameter a₁ and the metal of the second layer has a lattice parameter a₂, where a₁ and a₂ satisfy the following formula:
([sqrt(2)/2]*a₂)/a₁=x,
where x represents a value in a range of from 0.75 to 1.4.

4. The electrode of claim 1, wherein the first layer comprises the inorganic material in an amount of from 50% to 100% by weight of the first layer.

5. The electrode of claim 1, wherein the layer comprising a metal comprises a noble metal.

6. The electrode of claim 1, wherein the layer comprising a metal has a thickness of 50 nm and the electrode has a sheet resistance of no greater than 1.50 Ohm/sq.

7. The electrode of claim 1, wherein the layer comprising a metal has a thickness of from 20 nm to 70 nm.

8. The electrode of claim 1, wherein the first layer comprises the inorganic material in an amount of no greater than 75%.

9. The electrode of claim 1, wherein the first layer comprises the inorganic material in an amount of no less than 50% by weight of the first layer.

10. A biosensor test strip comprising:
an electrode system that includes an electrode, the electrode comprising:
a substrate;
a first layer comprising an inorganic material; and
a second layer comprising a metal,
wherein the first layer is disposed between the substrate and the second layer.

11. The biosensor test strip of claim 10, wherein the inorganic material comprises aluminum zinc oxide (AZO), indium tin oxide (ITO), antimony tin oxide (ATO), fluorine tin oxide (FTO), or any combination thereof.

12. The biosensor test strip of claim 10, wherein the inorganic material of the first layer has a lattice parameter a₁ and the metal of the second layer has a lattice parameter a₂, where a₁ and a₂ satisfy the following formula:
[(sqrt(2)/2]*a₂)/a₁=x,
where x represents a value in a range of from 0.75 to 1.4.

13. The biosensor test strip of claim 10, wherein the first layer comprises the inorganic material in an amount of from 50% to 100% by weight of the first layer.

14. The biosensor test strip of claim 10, wherein the layer comprising a metal comprises a noble metal.

15. The biosensor test strip of claim 10, wherein the layer comprising a metal has a thickness of 50 nm and the electrode has a sheet resistance of no greater than 1.50 Ohm/sq.

16. A method of forming an electrode, comprising:
providing a substrate;
depositing on the substrate a first layer comprising an inorganic material; and
depositing heteroepitaxially on the first layer a second layer comprising a metal, the second layer having a thickness of greater than 20 nm.

17. The method of claim 16, wherein the first layer is deposited directly onto the substrate, the layer comprising the metal is deposited directly onto the dielectric layer, or both.

18. The method of claim 16, wherein the first layer is deposited by sputtering, the second layer is deposited by sputtering, or both.

19. The method of claim 16, wherein the first layer and the second layer are deposited simultaneously using a roll-to-roll coater.

20. The method of claim 16, wherein the inorganic material of the first layer has a standard deposition rate.
